(19) United States
(12) Patent Application Publication
(10) Pub. No.: US 2014/0148207 A1
(43) Pub. Date: May 29, 2014

(54) COMMUNICATION SYSTEM AND COMMUNICATION TERMINAL CONNECTION METHOD

(71) Applicant: Yasuhiro Sano, Kyoto-shi (JP)

(72) Inventor: Yasuhiro Sano, Kyoto-shi (JP)

(73) Assignee: You-Wing Co., Ltd., Kyoto-shi, Kyoto (JP)

(21) Appl. No.: 14/130,355

(22) PCT Filed: Jul. 2, 2012
(86) PCT No.: PCT/JP2012/066862

§ 371 Date: Dec. 31, 2013

(30) Foreign Application Priority Data
Jun. 11, 2012 (JP) 2012-131647
Jun. 25, 2012 (JP) 2012-141675

(51) Int. Cl. H04W 56/00

(52) U.S. Cl. CPC H04W 56/002
USPC 455/507

(57) ABSTRACT

A communication system in which plural portable communication terminals present in a relatively narrow area are safely and securely matched and connected to each other by a simple operation, to exchange various types of information therebetween. When front sides of smartphone terminals are bought close to each other, either one of proximity sensors reacts or detects first. The reacted smartphone terminal allows a bottom speaker to generate ultrasound (e.g., 20 Khz), allows a back LED to light up, and stores the time at which the ultrasound has been detected. When the smartphone terminals are distanced from each other, both of the smartphone terminals stop detecting ultrasound by bottom microphones, and transmit a first reception time information and a second non-reception time information to a web server. The web server groups together and connects the two smartphone terminals, based on the received first time and second time.

### TECHNICAL FIELD

The present invention relates to a communication system and a communication terminal connection method, and more specifically to a communication system in which a plurality of portable communication terminals are connected to a server device through a network and set a current time using time information provided by the server device, and data communication is performed between portable communication terminals grouped together by the server device, and the like.

The present invention relates to a communication system in which after a plurality of portable communication terminals are uniformly connected to a server device through a network and achieve synchronization with time information of the server device, the plurality of portable communication terminals generate sound with a specific frequency in conjunction with reaction of their respective proximity sensors, by which microphones included in the respective portable communication terminals obtain “sound reception time information of the frequency sound (units of less than a second)”, and the plurality of portable communication terminals stop the sound with the specific frequency in conjunction with reset of their respective proximity sensors, by which the microphones included in the respective portable communication terminals obtain “non-sound reception time information of the frequency sound (units of less than a second)”, and data communication is performed by grouping the plurality of portable communication terminals together by the server device using the sound reception time information and the non-sound reception time information, as group authentication information (private key) with a high level of safety, and relates to simple human natural operation for implementing this technique.

In addition, the present invention also relates to a program of the above-described method (steps or a procedure) itself that is recorded in an information storage medium such as a semiconductor memory, a USB memory, an LD (LaserDisc (registered trademark)), an HD (hard disk), an FD (flexible disk), an MD (MiniDisc), a CD (compact disc), or a DVD (digital versatile disc or digital video disc).

### BACKGROUND ART

In recent years, portable communication terminals called smartphones have begun to proliferate rapidly, and are going to take over feature phones (general term) which have experienced a Japan's original evolution. However, the fact is that, while almost all models of feature phones have an infrared communication function, an overwhelming number of models of smartphones do not have an infrared communication function. Thus, to exchange information between the smartphones, the smartphones need to be connected to each other in some kind of way. In particular, for phone book and contact book exchange, mutual communication using a QR code (registered trademark) or Bluetooth (registered trademark) is performed.

However, for a system by mutual reading using a QR code (registered trademark), the “mutual operation” itself is the greatest trouble. P-to-P connection (peer-to-peer connection) by Bluetooth (registered trademark) takes a very long time to establish communication, and it requires on the order of 15 seconds on average. In addition, for a common matter for these connection methods, in either case, a connection is established by pairing communication (one to one) and thus it is not possible to implement simultaneous connection of three or more smartphones. In addition, in the case of connection using only a GPS function, it is highly likely that strangers in the same area are connected to each other, which can be said to be very dangerous in terms of personal information leakage.

Under these circumstances, for phone book and contact book exchange, there is a demand for communication methods that solve the existing problems. If the problems are solved satisfactorily, sharing of photos, video, and calendars, SNSs (Social Networking Services) and chat, participation in videophone, instant setup of battle and multiplayer games such as Japanese chess and car racing, and other instant exchange of various information between a plurality of users are further easily implemented.

In Patent Document 1, the object is to “perform wireless communication in ad-hoc mode by easily creating shared information (private key) with a high level of safety in a plurality of communication terminal devices”. Patent Document 1 discloses a method of creating shared information in communication terminal devices, in which “two communication terminal devices are held together and shaken a plurality of times to generate acceleration data in each communication terminal device. Each communication terminal device extracts peak positions Pa1 to Pa5 or peak positions Pb1 to Pb5 from its acceleration data. Times ta1 to ta4 and tb1 to tb4 between the peak positions are irregular and common information between the two communication terminal devices. Each communication terminal device creates shared information which is composed of a plurality of the same bit information, from the times between the peak positions. Using the shared information, mutual authentication is performed between the two communication terminal devices and encryption is further performed.” However, connection operation is troublesome again, and in addition, communication can only be performed between two communication terminal devices.

### PRIOR ART DOCUMENT

### Patent Document

Patent Document 1: JP 2011-130224 A

### DISCLOSURE OF THE INVENTION

### Problems to be Solved by the Invention

Under such circumstances, application software (which may hereinafter be simply called “applications”) called BUMP (Bump Technologies, Inc.) and LINE (NHN Japan Corporation) are developed. Both of the applications use a GPS function provided to smartphone terminals, and thus, GPS needs to be turned on upon use.

FIGS. 1 and 2 are schematic diagrams of display screens of a smartphone terminal. As shown in FIGS. 1(A) and 1(B), BUMP is an application that allows held smartphone terminals to bump together to connect the smartphone terminals, by which contact information, photos/images, and a calendar schedule (events) can be exchanged therebetween.

In addition, as shown in FIGS. 2(A) to 2(D), LINE has the “Shake it!” feature in which by your shaking your smartphone terminal together with your friend nearby, the friend nearby is found and by both of you checking and “adding” each other, you can be added as friends. These applications are free and can allow to exchange information by easy operation, and thus, are downloaded and used tens of millions of times or more around the world.

However, their mechanisms are such that a connection is established triggered by the shakes of smartphone terminals present in the same location or present nearby or by the change in acceleration caused by shakes, which may result in matching with people in a certain wide area. For example, a play called “one-person Bump” is performed where a user keeps shaking his/her terminal alone expecting to meet new people, and waits for strangers of the opposite gender to be connected thereto. For the “Shake it!” feature of LINE, too, by a user keeping shaking his/her terminal expecting to be connected to strangers by the same mechanism as that described above, the same result as that of the “one-person Bump” can be expected. Furthermore, there is also the fact that the posting entitled “Caution: it is dangerous to use LINE by changing a mobile phone number” is actually alerted on the Internet by the operator itself.

The present invention is made to solve mainly the above-described problems, and an object of the present invention is to provide a communication system and a communication terminal connection method, in which a plurality of portable communication terminals present in a relatively narrow area are safely and securely matched (grouped together) and connected to each other by simple operation, by which various types of information can be exchanged therebetween.

There is also a provision service in which in portable communication terminals, an ID itself which serves as specific authentication is converted into sound, and one portable communication terminal transmits the sound and the other receives the sound, by which a server groups the portable communication terminals together. However, according to the present invention, an initial role setting (the transmitting side and the sound receiving side) becomes unnecessary, and by all portable communication terminals only performing the same simple operation, two or more portable communication terminals are grouped together. Thus, an inconvenience of the existing provision service is also resolved.

### Means for Solving the Problems

To achieve the above-described object, a communication system of the present invention according to a first aspect is such that a plurality of portable communication terminals are connected to a server device through a network and set a current time using time information provided by the server device, and data communication is performed between portable communication terminals grouped together by the server device. In the communication system, each portable communication terminal includes: a sound source that generates sound with a predetermined frequency when a proximity sensor reacts; and a transmitting unit that transmits reception time information and non-reception time information to the server device, the reception time information indicating a time at which a microphone has received the sound with the predetermined frequency, and the non-reception time information indicating a time at which the microphone has stopped receiving the sound with the predetermined frequency, and the server device groups two or more portable communication terminals together based on reception time information and non-reception time information received from a plurality of portable communication terminals, to enable data communication through the network.

In the communication system of the first aspect, a communication system of the present invention according to a second aspect is such that the predetermined frequency of the sound generated by the sound source is a non-audible frequency.

In the communication system of the first or second aspect, a communication system of the present invention according to a third aspect is such that a display unit that displays a fact that the sound source is generating the sound with the predetermined frequency, or a vibrator that notifies by vibration that the sound source is generating the sound with the predetermined frequency.

A communication terminal connection method of the present invention according to a fourth aspect is such that a plurality of portable communication terminals are connected to a server device through a network and set a current time using time information provided by the server device, and data communication is performed between portable communication terminals grouped together by the server device. The method includes a first step of allowing a sound source to generate sound with a predetermined frequency when a proximity sensor included in each portable communication terminal reacts; a second step of transmitting reception time information and non-reception time information to the server device from a transmitting unit, the reception time information indicating a time at which a microphone included in each portable communication terminal has received the sound with the predetermined frequency, and the non-reception time information indicating a time at which the microphone has stopped receiving the sound with the predetermined frequency; and a third step of grouping, by the server device, two or more portable communication terminals together based on reception time information and non-reception time information received from a plurality of portable communication terminals, to enable data communication between the grouped portable communication terminals through the network.

A communication system of the present invention according to a fifth aspect is such that after a plurality of portable communication terminals are uniformly connected to a server device through a network and achieve synchronization with time information of the server device, the plurality of portable communication terminals generate sound with a specific frequency in conjunction with reaction of their respective proximity sensors, by which microphones included in the respective portable communication terminals obtain sound reception time information of the frequency sound, and the plurality of portable communication terminals stop the sound with the specific frequency in conjunction with reset of their respective proximity sensors, by which the microphones included in the respective portable communication terminals obtain non-sound reception time information of the frequency sound, and data communication is performed by grouping the plurality of portable communication terminals together by the server device using the sound reception time information and the non-sound reception time information, as group authentication information with a high level of safety.

A communication system of the present invention according to a sixth aspect is such that a plurality of portable communication terminals are connected to a server device through a network and set a current time using time information provided by the server device, and data communication is performed between portable communication terminals grouped together by the server device. In the communication system, each portable communication terminal includes: a sound source that generates sound with a predetermined frequency when a proximity sensor reacts; a sound detecting unit that detects reception of the sound with the predetermined frequency by a microphone, by comparing with a threshold value; and a transmitting unit that transmits detection time information and non-detection time information to the server device, the detection time information indicating a time at which the sound detecting unit has detected the sound with the predetermined frequency, and the non-detection time information indicating a time at which the sound detecting unit has stopped detecting the sound with the predetermined frequency, and the server device groups two or more portable communication terminals together based on detection time information and non-detection time information received from a plurality of portable communication terminals, to enable data communication between the grouped portable communication terminals through the network.

In the communication system of the sixth aspect, a communication system of the present invention according to a seventh aspect is such that each portable communication terminal raises a threshold value of the sound detecting unit when grouping is not performed despite a fact that the proximity sensor has repeated reaction and non-reaction.

In the communication system of the seventh aspect, a communication system of the present invention according to an eighth aspect is such that each portable communication terminal raises the threshold value of the sound detecting unit, according to the number of times reaction and non-reaction are repeated by the proximity sensor.

In the communication system of any one of the sixth to eighth aspects, a communication system of the present invention according to a ninth aspect includes a display unit that displays a fact that the sound source is generating the sound with the predetermined frequency, or a vibrator that notifies by vibration that the sound source is generating the sound with the predetermined frequency.

A communication terminal connection method of the present invention according to a tenth aspect is such that a plurality of portable communication terminals are connected to a server device through a network and set a current time using time information provided by the server device, and data communication is performed between portable communication terminals grouped together by the server device. The method includes: a first step of allowing a sound source to generate sound with a predetermined frequency when a proximity sensor included in each portable communication terminal reacts; a second step of detecting reception of the sound with the predetermined frequency by a microphone included in each portable communication terminal, by comparing with a threshold value; a third step of transmitting detection time information and non-detection time information to the server device, the detection time information indicating a time at which the sound with the predetermined frequency has been detected, and the non-detection time information indicating a time at which a sound detecting unit has stopped detecting the sound with the predetermined frequency; and a fourth step of grouping, by the server device, two or more portable communication terminals together based on detection time information and non-detection time information received from a plurality of portable communication terminals, to enable data communication between the grouped portable communication terminals through the network.

### Effect of the Invention

According to a communication system of the present invention, a portable communication terminal allows a sound source to generate sound with a predetermined frequency when a proximity sensor reacts, and transmits reception time information indicating a time at which a microphone has received the sound with the predetermined frequency, and non-reception time information indicating a time at which the microphone has stopped receiving the sound with the predetermined frequency, to a server device from a transmitting unit. The server device groups two or more portable communication terminals together based on reception time information and non-reception time information received from a plurality of portable communication terminals, to enable data communication through a network. Namely, portable communication terminals having the same reception time information and the same non-reception time information are grouped together. Therefore, there is a specific effect that a plurality of portable communication terminals can be safely and securely grouped together and connected to each other by simple operation.

According to the communication system of the present invention, the predetermined frequency of the sound generated by the sound source is a non-audible frequency. Thus, when two or more portable communication terminals are grouped together, no trouble is caused to people nearby.

According to the communication system of the present invention, a display unit displays the fact that the sound source is generating sound with the predetermined frequency, or a vibrator notifies by vibration that the sound source is generating sound with the predetermined frequency. Thus, when two or more portable communication terminals are grouped together, users can see at a glance that the portable communication terminals are in a preparation state (or a standby state).

According to the communication system of the present invention, a threshold value of a sound detecting unit is raised when grouping is not performed despite the fact that the proximity sensor has repeated reaction and non-reaction. Thus, the influence of interfering sound waves is not received.

According to a communication terminal connection method of the present invention, the same effects as those of the above-described communication system of the present invention can be exerted.

### BRIEF DESCRIPTIONS OF THE DRAWINGS

FIG. 1 A schematic diagram of display screens of a smartphone terminal.

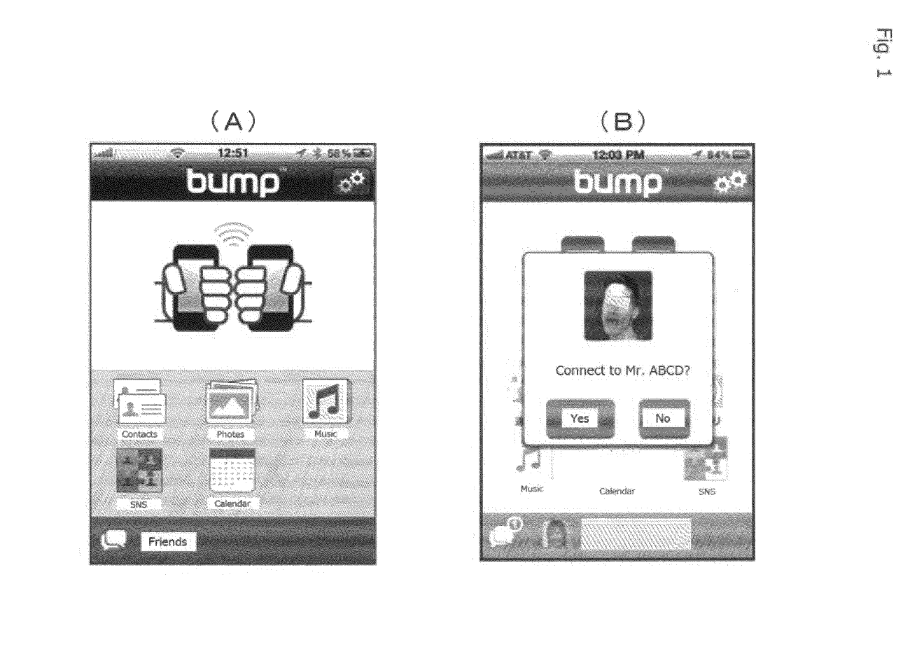

FIG. 2 A schematic diagram of display screens of the smartphone terminal.

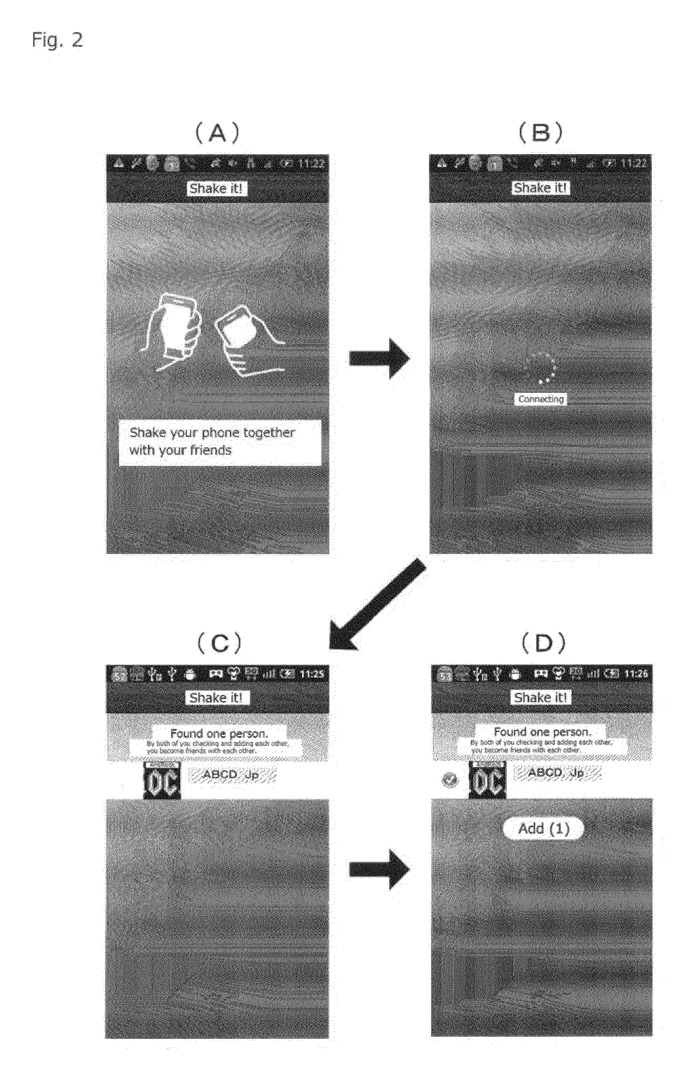

FIG. 3 A block diagram showing an electrical configuration of a portable communication terminal.

FIG. 4 An external view of the portable communication terminal.

FIG. 5 A block diagram showing an overall configuration of a communication system of the present invention.

FIG. 6 An illustrative diagram of the operation of a smartphone terminal.

FIG. 7 An illustrative diagram of the operation of the smartphone terminal.

FIG. 8 An illustrative diagram showing reception time information and non-reception time information of ultrasound.

FIG. 9 An illustrative diagram showing reception time information and non-reception time information of ultrasound.

FIG. 10 A conceptual diagram of authentication and connection in group mode.

FIG. 11 A conceptual diagram of authentication and connection in face-to-face mode.

FIG. 12 A conceptual diagram of authentication and connection in pair mode.

### BEST MODE FOR CARRYING OUT THE INVENTION

An embodiment of the present invention will be described in detail below with the drawings. Note that although as examples of a portable communication terminal used in a communication system, etc., of the present invention, a smartphone terminal is described as an example, the present invention can also be applied to tablet terminals which have come out recently and conventional mobile phones (CDMA terminals, PDC terminals, PHS terminals, and PDA terminals).

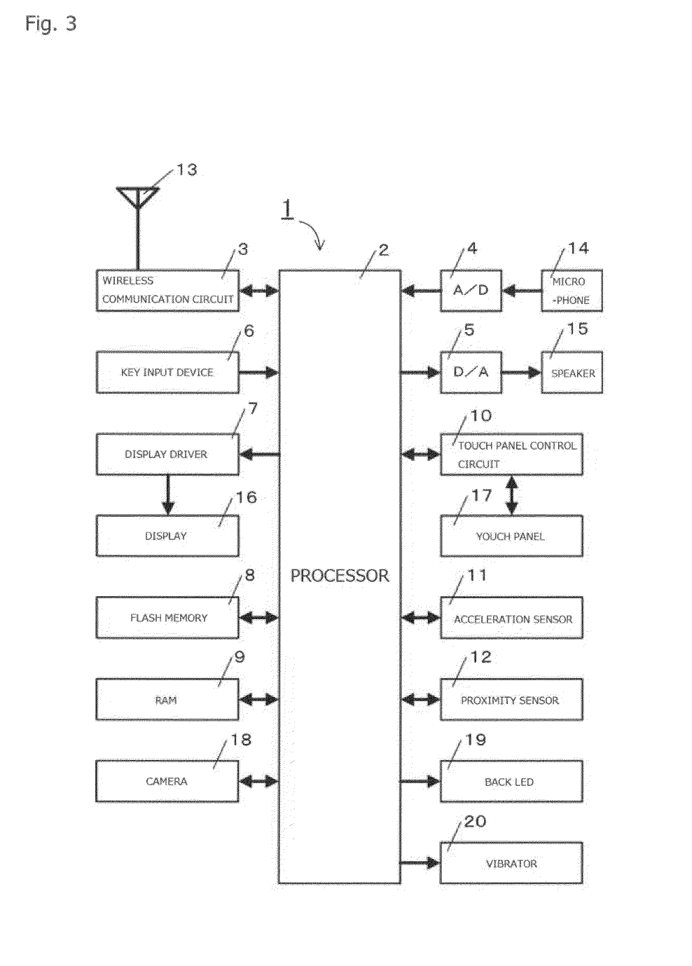

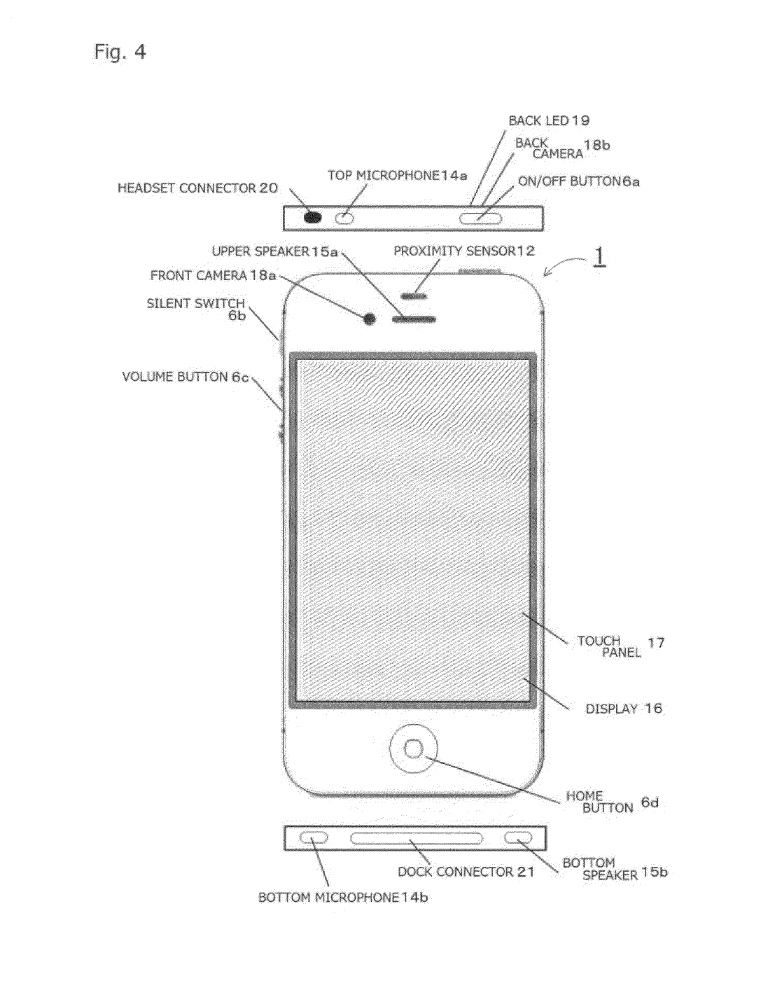

FIG. 3 is a block diagram showing an electrical configuration of a portable communication terminal. FIG. 4 is an external view of the portable communication terminal.

A smartphone terminal 1 which is a kind of portable communication terminal includes a processor 2 called a CPU or computer. To the processor 2 are connected a wireless communication circuit 3, an A/D converter 4, a D/A converter 5, a key input device 6, a display driver 7, a flash memory 8, a RAM 9, a touch panel control circuit 10, an acceleration sensor 11, a proximity sensor 12, a camera 18, a back LED 19, and a vibrator 20. An antenna 13 is connected to the wireless communication circuit 3, a microphone 14 is connected to the A/D converter 4, and a speaker 15 (also referred to as the “receiver”) is connected to the D/A converter 5 through an amplifier (not shown). In addition, a display 16 which functions as a display unit is connected to the display driver 7. A touch panel 17 is connected to the touch panel control circuit 10. The camera 18 includes a front camera 18a and a back camera 18b.

The processor 2 is an IC for control and performs overall control of the smartphone terminal 1. In addition, the RAM 9 is used as a work area (including a rendering area) or buffer area of the processor 2. The flash memory 8 records or stores therein data on content such as the characters, images, audio, sound, and video of the smartphone terminal 1 and various types of application software.

The A/D converter 4 converts an analog audio signal of audio or sound inputted through the microphone 14 connected to the A/D converter 4 into a digital audio signal. The microphone 14 includes a top microphone 14a and a bottom microphone 14b. The D/A converter 5 converts (decodes) a digital audio signal into an analog audio signal and provides the analog audio signal to the speaker 15 through the amplifier. Therefore, audio or sound corresponding to the analog audio signal is outputted from the speaker 15. The speaker 15 includes an upper speaker 15a and a bottom speaker 15b. As other components, a headset connector 20 and a dock connector 21 are provided.

In particular, by allowing a part of an analog audio signal obtained by the bottom microphone 14b to pass through a 20 Khz bandpass filter and comparing the passed signal level with a threshold value (reference value), either one of a reception state and a non-reception state of 20 Khz ultrasound is detected. For example, analog technically, when the threshold voltage of a comparator is 1 volt, if the sound pressure level of the passed signal exceeds 1 volt, then it is a reception state of ultrasound; on the other hand, if not exceeding 1 volt, then it is a non-reception state of ultrasound. As a matter of course, when detection is performed digitally, a numerical comparison between the received sound pressure level of 20 Khz ultrasound and a threshold level only needs to be made. This threshold value is variable and thus can be adjusted to a desired value. When grouping is not performed despite the fact that the proximity sensor 12 has repeated reaction and non-reaction, the processor 2 raises the threshold level and thereby eliminates the influence of neighboring ultrasonic noise. In addition, the threshold level is raised little by little, according to the number of times reaction and non-reaction are repeated by the proximity sensor 12. Note that for a known technique for determining the sound pressure level of an audio signal in each frequency band, there is one described in JP 11-225031 A, and this technique can be used.

The key input device 6 is composed of an on/off button 6a, a silent switch 6b, a volume button 6c, and a home button 6d which are shown in FIG. 4. Information on a key operated by a user (key data) is inputted to the processor 2. Note that when each key included in the key input device 6 is operated, click sound is made. Thus, the user can obtain operational feeling for various types of key operation by hearing click sound. Note, however, that it is also possible to set silent mode where operation sound is turned off. The user turns on/off the power to the smartphone terminal 1 by long pressing the on/off button 6a.

The display driver 7 controls display provided on the display 16 connected to the display driver 7, by an instruction from the processor 2. In addition, the display driver 7 includes a VRAM (not shown) which temporarily stores image data to be displayed. The processor 2 allows the VRAM to store image data to be displayed on the display 16.

The touch panel 17 adopts a capacitive system that detects a change in capacitance between electrodes, which results from an approach of an object such as a finger to a surface, and can detect a touch of one or a plurality of fingers on the touch panel 17. In addition, the touch panel 17 is a pointing device for instructing an arbitrary position within a screen of the display 16. For example, when the touch panel 17 is operated by pressing, stroking, and touching the surface thereof with a finger, the touch panel 17 detects those operations. When a finger touches the touch panel 17, the touch panel control circuit 10 which functions as a touch detecting unit identifies the position of the finger and outputs coordinate data indicating the operated position to the processor 2. That is, the user can input an operation direction, graphics, etc., to the smartphone terminal 1 by, for example, touching the surface of the touch panel 17 with a finger. Note that touch operation is not limited to being performed with a finger, and may be performed with a touch pen, etc. Note also that for the detection system for the touch panel 17, a surface capacitive system may be adopted, or a resistive system, an ultrasonic system, an infrared system, and an electromagnetic system may be adopted.

The acceleration sensor 11 is, for example, a semiconductor type 3-axis acceleration sensor and outputs acceleration data on each axis to the processor 2. The processor 2 calculates the posture (in other words, the angle) of the smartphone terminal 1 using an inverse trigonometric function for the value of acceleration of each axis. The acceleration sensor 11 detects the posture of the smartphone terminal 1 in this manner and thus may also be called a posture detecting unit.

The proximity sensor 12 is, for example, a touch sensor of a capacitive system and detects an approach (touch) of the user's finger, face, etc., by a change in capacitance. In addition, when a close approach of a face is detected by the proximity sensor 12 during a call, the power to the display 16 is turned off to invalidate a touch on the touch panel 17. Note that for the proximity sensor 12 using a touch sensor of a capacitive system, an appropriate one can be used, such as a projection type that detects a close approach of a finger by measuring the ratio of the amounts of current by multiple electrode patterns, or a surface type that is composed of a conductive film and a substrate and detects a close approach of a finger by forming a uniform electric field by the conductive film. Note also that the proximity sensor 12 may also be called a specific state detecting unit.

Note that the proximity sensor is a generic term for sensors that aim to detect a detection target without touching the detection target, as an alternative to a touch type detection system such as a limit switch, and converts the movement information and presence information of a detection target into electrical signals. In addition to the capacitive system, there are a system that uses eddy current which is generated in a metal body serving as a detection target due to electromagnetic induction, and a system that uses a magnet and a reed switch.

The wireless communication circuit 3 is a circuit for performing wireless communication for a CDMA system (IMT-2000) called the third generation. For example, when the user operates an icon displayed on the display 16 using the touch panel 17 to instruct to make a call, the wireless communication circuit 3 performs an outgoing call process under an instruction from the processor 2, to output an outgoing call signal through the antenna 12. The outgoing call signal is transmitted to a telephone at the other end through a base station and a telephone communication network (not shown). Then, when the telephone at the other end performs an incoming call process, it goes into a communicable state and thus the processor 2 performs a call process. Note that the wireless communication circuit 3 also includes a fourth-generation system called IMT-Advanced, and WIFI.

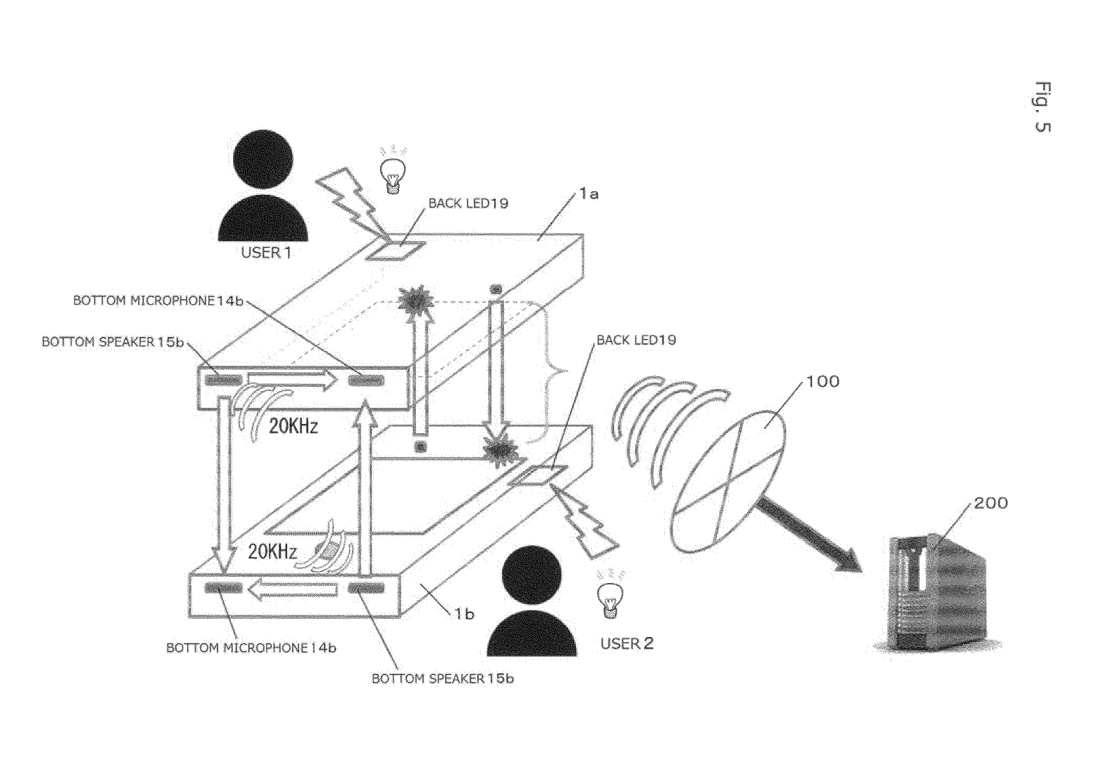

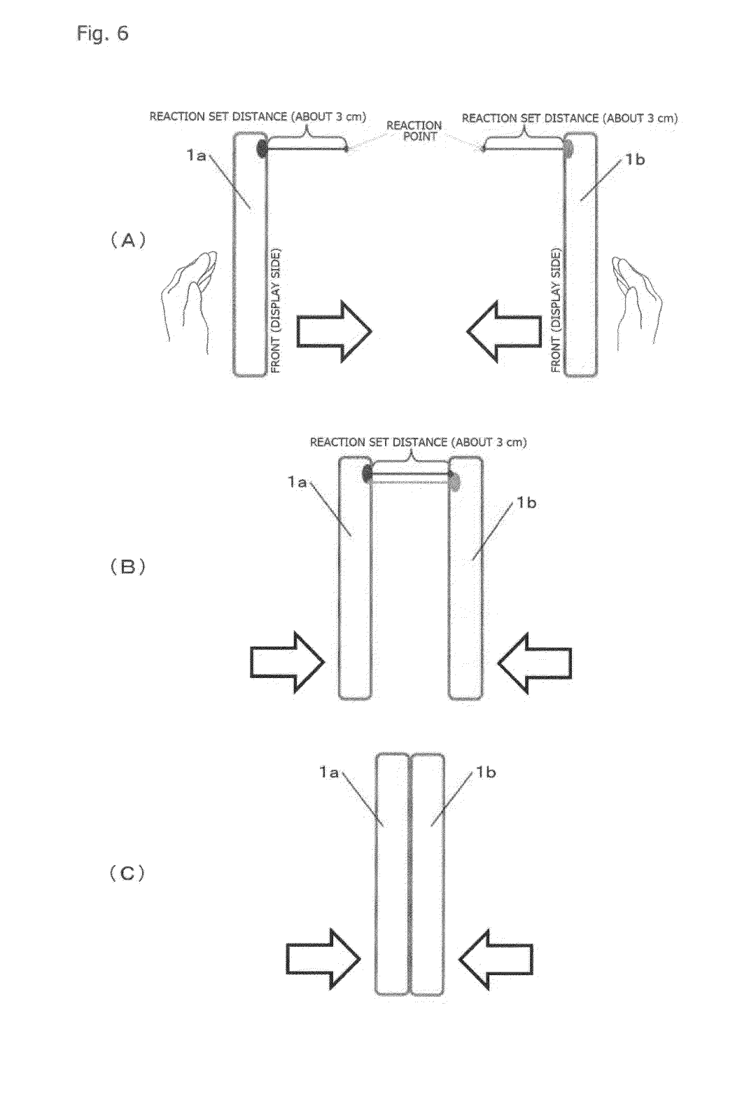

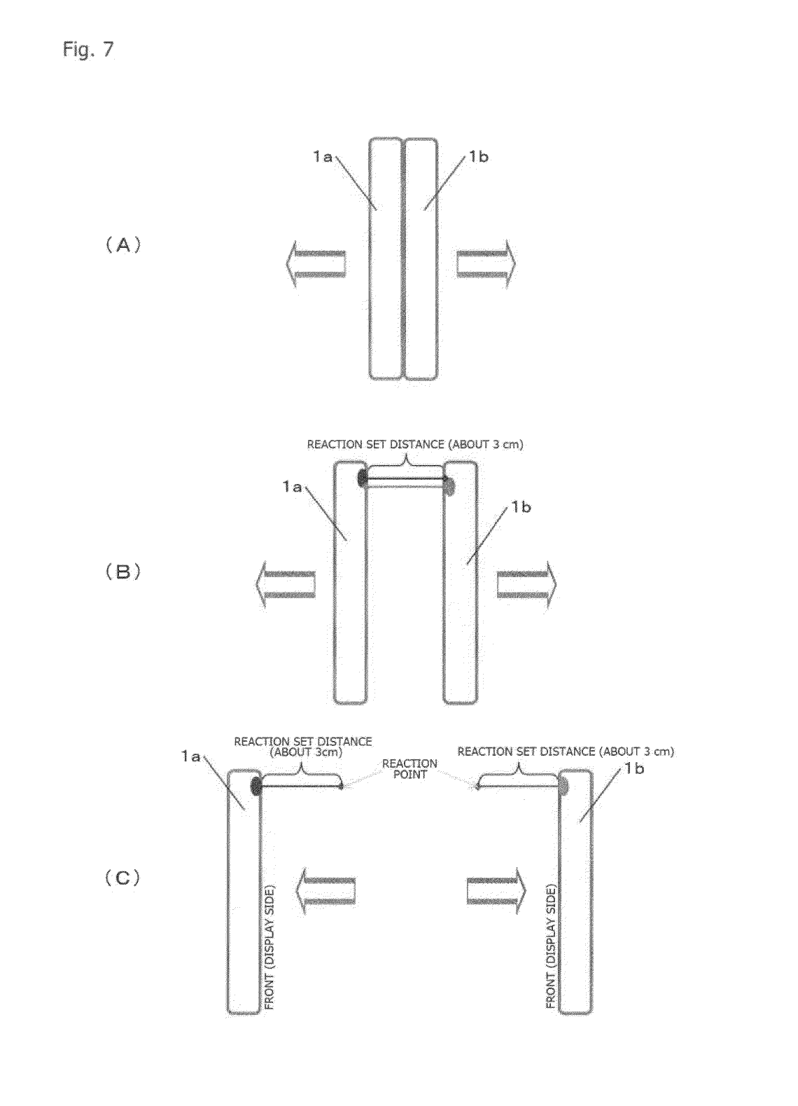

FIG. 5 is a block diagram showing an overall configuration of a communication system of the present invention. FIGS. 6 and 7 are illustrative diagrams of the operation of a smartphone terminal. The operation of the system will be described.

A smartphone terminal 1a and a smartphone terminal 1b are provided with a browser for browsing web pages (also known as web browser), and are connected to a web server 200 through Internet 100 (including a base station and an access point) which is a communication network, and thus can download HTML files, image files, music files, etc., and analyze the layout of a website to display and reproduce the website. In addition, the smartphone terminal 1a and the smartphone terminal 1b can download various types of application software written in Java (registered trademark), Flash, etc., from the web server 200 and can allow the application software to run.

It is assumed that a user 1 owns the smartphone terminal 1a and a user 2 owns the smartphone terminal 1b, and a grouping application which is dedicated software is already installed. The applicant of the present application has already developed the grouping application as a dedicated application, and there are pair mode in which only two smartphone terminals 1 are grouped together, and group mode in which three or more smartphone terminals 1 are grouped together.

### EXAMPLES

### Example 1

### Pair Mode

First, when each smartphone terminal 1 starts up the grouping application, each smartphone terminal 1 is connected to the web server 200 through the Internet 100. The web server 200 obtains IP addresses and UNIDs (terminals' unique identification numbers) from the smartphone terminals 1, and transmits time information. Each smartphone terminal 1 sets the current time using the time information received from the web server 200, by which time sync (time synchronization) between the two smartphone terminals 1 can be achieved.

When, in this preparation state, the user 1 and the user 2 bring the front sides (sides on the side of the displays 16) of the smartphone terminal 1a and the smartphone terminal 1b close to each other with the front sides facing each other (see FIG. 6(A)) and the distance therebetween reaches on the order of about 3 cm, either one of the proximity sensors 12 reacts or detects first (see FIG. 6(B)). To put it the other way around, there is no chance of the two proximity sensors 12 reacting simultaneously.

The reacted smartphone terminal 1 allows the bottom speaker 15b to generate ultrasound (e.g., 20 Khz) at the time of the reaction, and allows the back LED 19 to light up or blink or allows the vibrator 20 to vibrate. It is desirable that the ultrasound be sound that human ears cannot hear (non-audible frequency sound) so that it does not become noise. In addition, the reason that the back LED 19 is allowed to light up or blink is to make the user see by his/her eyes that ultrasound is being generated, and the reason that the vibrator 20 is allowed to vibrate is to notify by vibration that ultrasound is being generated. Each smartphone terminal 1 records the time at which the 20 KHz ultrasound has been detected, using the bottom microphone 14b. That is, since the smartphone terminal 1 having generated the ultrasound also hears the sound generated thereby through the bottom microphone 14b, the smartphone terminals 1 record the same time. Note, however, that the smartphone terminal 1b which is the ultrasound generated side may record the time at which the ultrasound has been generated.

Then, when the smartphone terminals 1 are further brought close to each other, the other smartphone terminal 1 also reacts at the proximity sensor 12 and thus allows the bottom speaker 15b to generate ultrasound with the same frequency, and allows the back LED 19 to light up or blink or allows the vibrator 20 to vibrate. Then, finally, the displays 16 go into a state of overlapping each other (see FIG. 6(C)). In the state of FIG. 6(C), the smartphone terminal 1a and the smartphone terminal 1b record the same first time as reception time information, and allow the bottom speakers 15b to generate ultrasound, and allow the back LEDs 19 to, for example, light up or allow the vibrators 20 to vibrate. Note that although FIG. 6(C) shows a state in which the displays 16 overlap each other, it is sufficient that the two terminals come close to each other at a close distance at which both of the proximity sensors 12 react (on the order of 2 cm to 4 cm, though depending on the model).

Then, when, in the state shown in FIG. 7(A), the smartphone terminal 1a and the smartphone terminal 1b are distanced from each other and the distance therebetween reaches on the order of about 3 cm (see FIG. 7(B)), either one of the proximity sensors 12 stops reacting first, and thus, the generation of ultrasound is stopped and the back LED 19 is allowed to go out or the vibration of the vibrator 20 is stopped. However, since the other smartphone terminal 1 is reacting at the proximity sensor 12 and thus is generating ultrasound (e.g., 20 Khz), both of the smartphone terminals 1 continue to detect ultrasound by the bottom microphones 14b. Note that FIG. 7(A) has the same state as FIG. 6(C).

When both of the smartphone terminals 1 are further distanced from each other, the proximity sensor 12 of the other smartphone terminal 1 also stops reacting, and thus, the generation of ultrasound is stopped and the back LED 19 is allowed to go out or the vibration of the vibrator 20 is stopped (see FIG. 7(C)). Then, the smartphone terminal 1a and the smartphone terminal 1b record the same second time as non-reception time information indicating the time at which both the smartphone terminal 1a and the smartphone terminal 1b have stopped detecting ultrasound by the bottom microphones 14b, and transmit the first time (reception time information) and the second time (non-reception time information) to the web server 200.

The web server 200 groups the two smartphone terminals 1 together, based on the first time and the second time which are received from the smartphone terminal 1a and the smartphone terminal 1b through the Internet 100. That is, the smartphone terminals 1 having the same first time and the same second time are associated with the same group, and thereafter, data communication between the two smartphone terminals 1 is allowed through a communication network and the Internet 100. Note that it is preferred that this closing and distancing operation be repeated a plurality of times, by which erroneous connection is prevented, enabling to improve the reliability of grouping.

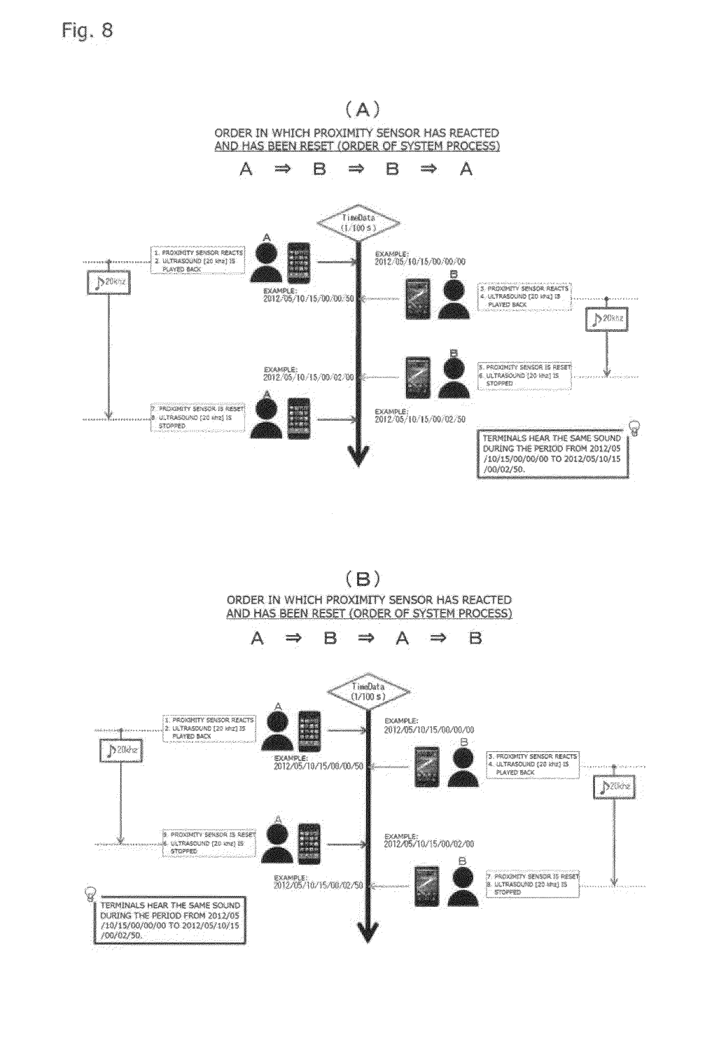

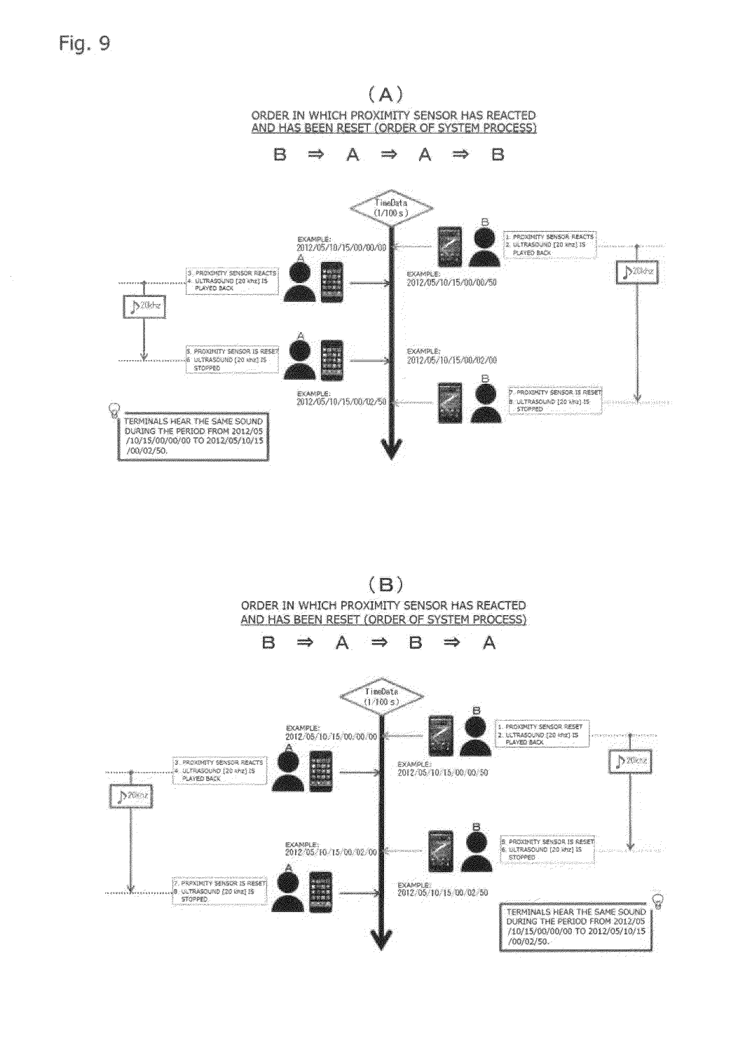

FIGS. 8 and 9 are illustrative diagrams showing reception time information and non-reception time information of ultrasound.

A user A (user 1) has the smartphone terminal 1a and a user B (user 2) has the smartphone terminal 1b. As described above, when the two terminals are brought close to each other to come into contact with each other and then are distanced from each other, the proximity sensors 12 react in any of FIGS. 7(A) and 7(B) to FIGS. 8(A) and 8(B), but in any case the smartphone terminals 1 both have completely the same first time (reception time information) and the same second time (non-reception time information). The web server 200 groups together the smartphone terminals 1 having the same first time and the same second time.

### Example 2

### Group Mode

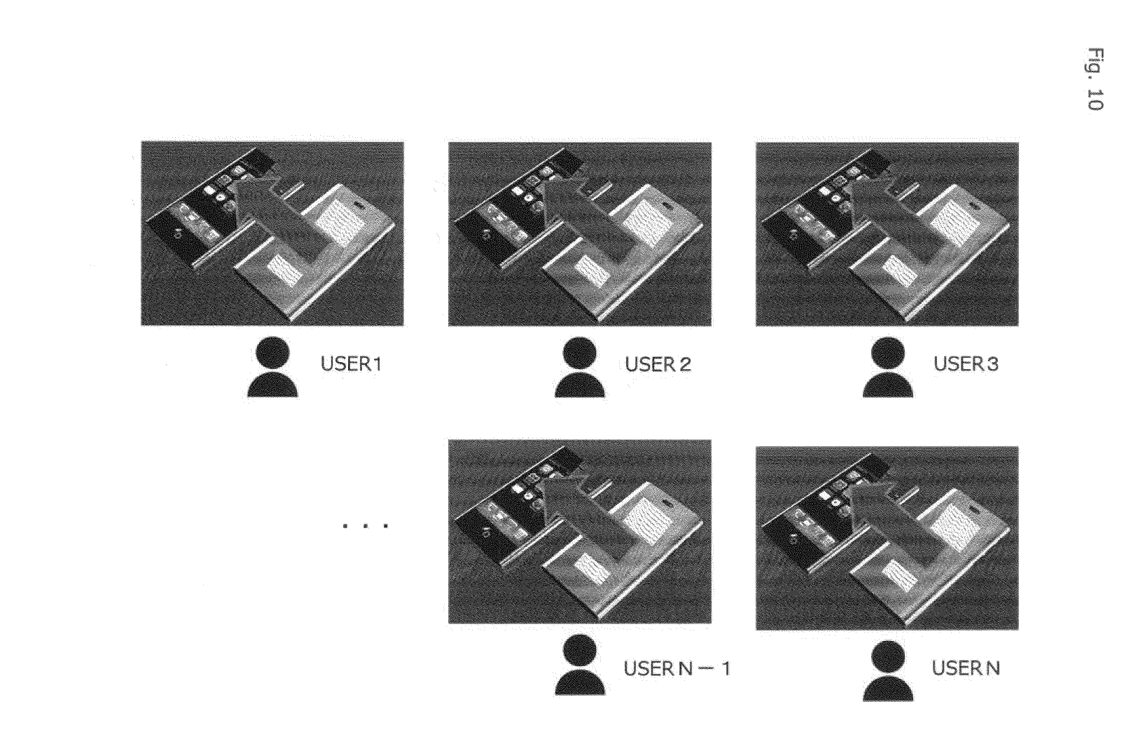

FIG. 10 is a conceptual diagram of authentication and connection in group mode.

The group mode is a mode in which theoretically smartphone terminals 1 can be grouped without limitation. For example, the grouping applications of smartphone terminals 1 to N owned by users 1 to N are allowed to start up, and at the same time as when the terminal screens thereof are turned down, the proximity sensors 12 react and the back LEDs 19 light up. When, after all of the users have confirmed that the back LEDs 19 on the back side light up, the screens are turned over again to the front side in the original state, all of the smartphone terminals 1 to N are automatically authenticated and connected to one another by the web server 200.

### Example 3

### Face-to-Face Mode

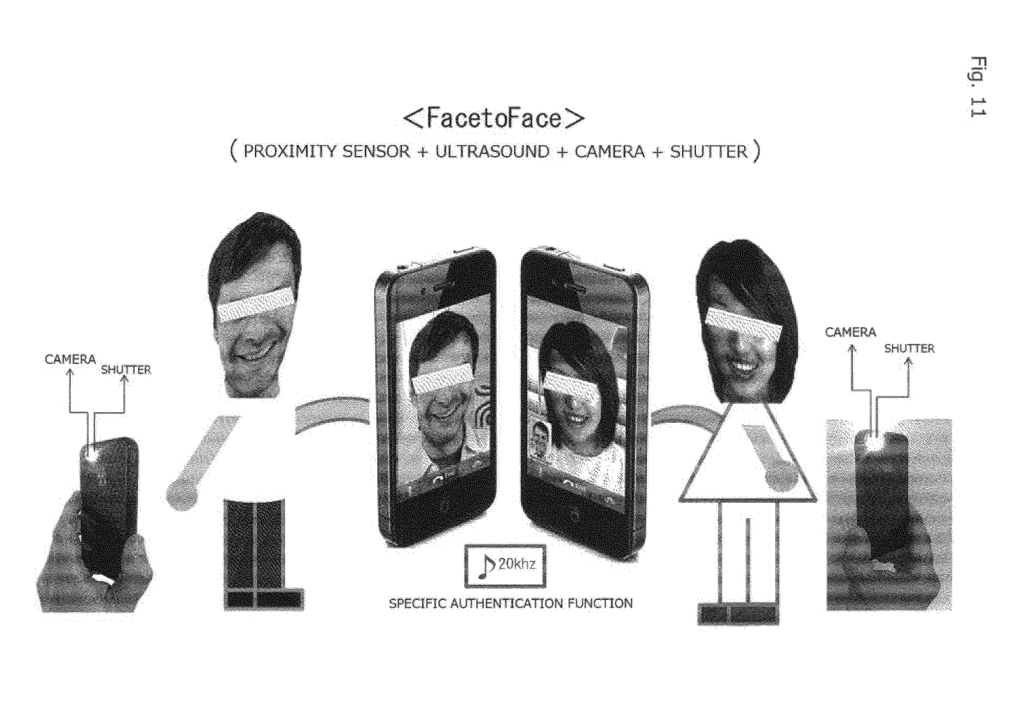

FIG. 11 is a conceptual diagram of authentication and connection in face-to-face mode.

The pair mode described in example 1 has a mechanism in which by allowing ultrasound transmission and lighting up of the back LED 19 to be performed in conjunction with each other, which is triggered by the proximity sensor 12, smartphone terminals are authenticated and connected to each other as a pair. In the present application pattern (face-to-face), by allowing ultrasound transmission and a camera shooting function and a shutter function to be performed in conjunction with one another, which is triggered by the proximity sensor 12 as well, smartphone terminals are authenticated and connected to each other as a pair. Note that a photo image of each user shot by the user is transmitted together with “basic profile (name, phone number, email address, etc.)” to be transmitted to the other user, and the photo image and the basic profile are registered in an address book of an application of a terminal having received the photo image and the basic profile. This is exactly the same as exchanging and registering an image or video shot by each person, together with basic information.

### Example 4

### Interference Elimination Function

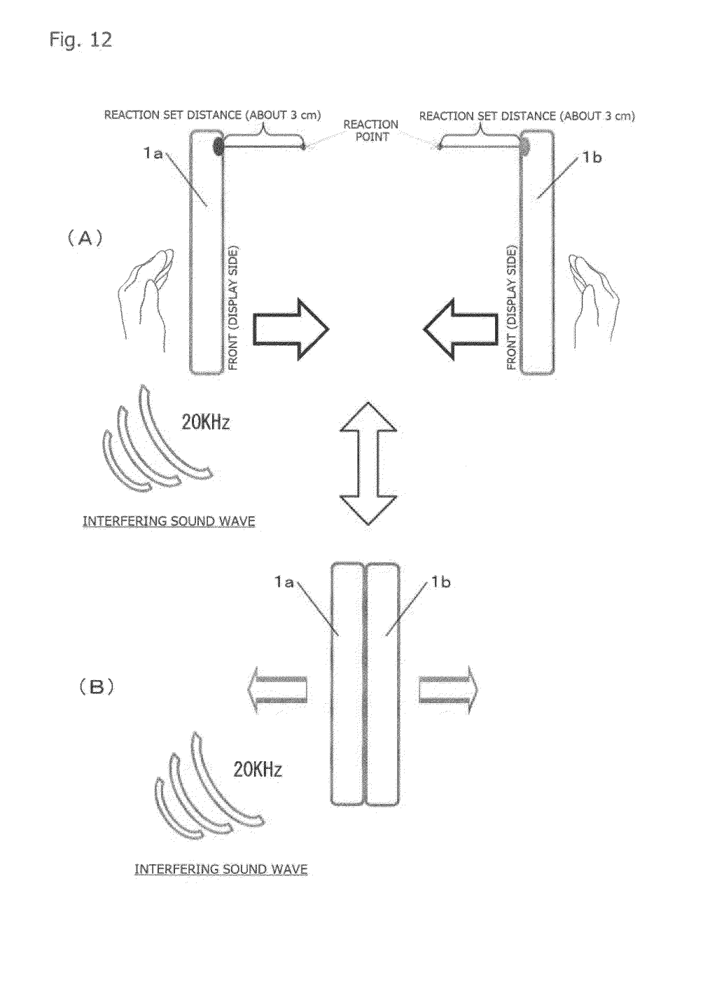

FIG. 12 is a conceptual diagram of authentication and connection in pair mode.

As described in FIGS. 6 and 7, it is a state in which the user 1 and the user 2 attempt to perform authentication and connection between the smartphone terminal 1a and the smartphone terminal 1b. It shows that in that state a relatively strong interfering sound wave with the same frequency of 20 KHz has reached (or is continuously produced) from surroundings. This situation is considered an interfering sound wave emitted from another smartphone terminal 1 which is present nearby unrelated to the user 1 and the user 2.

Even if, in the state shown in FIG. 12, the grouping applications of the smartphone terminal 1a and the smartphone terminal 1b which are owned by the user 1 and the user 2 are allowed to start up, and the sides on the side of the displays 16 are allowed to face each other at a distance (see FIG. 12(A)) and then are brought close to each other (see FIG. 12(B)), and the screens are distanced from each other in the original state, the 20 KHz interfering sound wave is continuously detected. Thus, non-reception time information cannot be obtained in one attempt, and accordingly, authentication and connection are not performed. That is, the smartphone terminals 1 compare the level of the interfering sound wave with the reference threshold level, but since the reference threshold level is low, the smartphone terminals 1 are influenced by interfering sound waves whose levels are stronger than the reference threshold level.

When the user 1 and the user 2 bring the smartphone terminal 1a and the smartphone terminal 1b close to each other again, the proximity sensors 12 react. Then, when the screens are distanced from each other, the proximity sensors 12 stop reacting. At that time, the smartphone terminal 1a and the smartphone terminal 1b raise the threshold level to a first threshold level which is higher by one level than the reference threshold level. Then, if authentication and connection have not been performed even so, the user 1 and the user 2 repeat the “bringing close to each other→distancing from each other” operation in the same manner again and again until a connection is established. The smartphone terminal 1a and the smartphone terminal 1b raise the threshold level to a second threshold level which is higher by one level than the first threshold level. The threshold level is raised in steps of one level, according to the number of times the “bringing close to each other→distancing from each other” operation is performed. Finally, the influence of the interfering sound wave is eliminated and thus the smartphone terminal 1a and the smartphone terminal 1b can obtain the same non-reception time information, resulting in that the smartphone terminal 1a and the smartphone terminal 1b are authenticated and connected to each other.

Note that in authentication and connection in group mode in example 2, too, since the threshold level is raised in steps of one level, according to the number of times the “turning down→turning over” operation is performed, all of the smartphone terminals 1 to N are automatically authenticated and connected to one another by the web server 200. In the case of the authentication and connection in group mode, a representative smartphone terminal 1 may input the number of smartphone terminals to be connected, to notify the web server 200 of the number. For example, when five smartphone terminals are grouped together, by one smartphone terminal notifying the web server 200 in advance of the number “5”, the web server 200 performs authentication and connection only after the web server 200 groups only five smartphone terminals together.

### EXPLANATION OF REFERENCE NUMERALS

1 SMARTPHONE TERMINAL
2 PROCESSOR
3 WIRELESS COMMUNICATION CIRCUIT
4 A/D CONVERTER
5 D/A CONVERTER
6 KEY INPUT DEVICE
7 DISPLAY DRIVER
8 FLASH MEMORY
9 RAM
10 TOUCH PANEL CONTROL CIRCUIT
11 ACCELERATION SENSOR
12 PROXIMITY SENSOR
13 ANTENNA
14 MICROPHONE
15 SPEAKER
16 DISPLAY
17 TOUCH PANEL
18 CAMERA
19 BACK LED
20 VIBRATOR
100 INTERNET
200 WEB SERVER

1. A communication system in which a plurality of portable communication terminals are connected to a server device through a network and set a current time using time information provided by the server device, and data communication is performed between portable communication terminals grouped together by the server device, wherein
each portable communication terminal includes:
a sound source that generates sound with a predetermined frequency when a proximity sensor reacts; and
a transmitting unit that transmits reception time information and non-reception time information to the server device, the reception time information indicating a time at which a microphone has received the sound with the predetermined frequency, and the non-reception time information indicating a time at which the microphone has stopped receiving the sound with the predetermined frequency, and
the server device groups two or more portable communication terminals together based on reception time information and non-reception time information received from a plurality of portable communication terminals, to enable data communication between the grouped portable communication terminals through the network.

2. The communication system according to claim 1, wherein
the predetermined frequency of the sound generated by the sound source is a non-audible frequency.

3. The communication system according to claim 1, comprising:
a display unit that displays a fact that the sound source is generating the sound with the predetermined frequency, or a vibrator that notifies by vibration that the sound source is generating the sound with the predetermined frequency.

4. A communication terminal connection method in which a plurality of portable communication terminals are connected to a server device through a network and set a current time using time information provided by the server device, and data communication is performed between portable communication terminals grouped together by the server device, the method comprising:
a first step of allowing a sound source to generate sound with a predetermined frequency when a proximity sensor included in each portable communication terminal reacts;
a second step of transmitting reception time information and non-reception time information to the server device from a transmitting unit, the reception time information indicating a time at which a microphone included in each portable communication terminal has received the sound with the predetermined frequency, and the non-reception time information indicating a time at which the microphone has stopped receiving the sound with the predetermined frequency; and
a third step of grouping, by the server device, two or more portable communication terminals together based on reception time information and non-reception time information received from a plurality of portable communication terminals, to enable data communication between the grouped portable communication terminals through the network.

5. A communication system in which after a plurality of portable communication terminals are uniformly connected to a server device through a network and achieve synchronization with time information of the server device, the plurality of portable communication terminals generate sound with a specific frequency in conjunction with reaction of their respective proximity sensors, by which microphones included in the respective portable communication terminals obtain sound reception time information of the frequency sound, and the plurality of portable communication terminals stop the sound with the specific frequency in conjunction with reset of their respective proximity sensors, by which the microphones included in the respective portable communication terminals obtain non-sound reception time information of the frequency sound, and data communication is performed by grouping the plurality of portable communication terminals together by the server device using the sound reception time information and the non-sound reception time information, as group authentication information with a high level of safety.

6. A communication system in which a plurality of portable communication terminals are connected to a server device through a network and set a current time using time information provided by the server device, and data communication is performed between portable communication terminals grouped together by the server device, wherein
each portable communication terminal includes:
a sound source that generates sound with a predetermined frequency when a proximity sensor reacts;
a sound detecting unit that detects reception of the sound with the predetermined frequency by a microphone, by comparing with a threshold value; and
a transmitting unit that transmits detection time information and non-detection time information to the server device, the detection time information indicating a time at which the sound detecting unit has detected the sound with the predetermined frequency, and the non-detection time information indicating a time at which the sound detecting unit has stopped detecting the sound with the predetermined frequency, and
the server device groups two or more portable communication terminals together based on detection time information and non-detection time information received from a plurality of portable communication terminals, to enable data communication between the grouped portable communication terminals through the network.

7. The communication system according to claim 6, wherein
each portable communication terminal raises a threshold value of the sound detecting unit when grouping is not performed despite a fact that the proximity sensor has repeated reaction and non-reaction.

8. The communication system according to claim 7, wherein
each portable communication terminal raises the threshold value of the sound detecting unit, according to the number of times reaction and non-reaction are repeated by the proximity sensor.

9. The communication system according to claim 6, comprising:
a display unit that displays a fact that the sound source is generating the sound with the predetermined frequency, or a vibrator that notifies by vibration that the sound source is generating the sound with the predetermined frequency.

10. A communication terminal connection method in which a plurality of portable communication terminals are connected to a server device through a network and set a current time using time information provided by the server device, and data communication is performed between portable communication terminals grouped together by the server device, the method comprising:
a first step of allowing a sound source to generate sound with a predetermined frequency when a proximity sensor included in each portable communication terminal reacts;
a second step of detecting reception of the sound with the predetermined frequency by a microphone included in each portable communication terminal, by comparing with a threshold value;
a third step of transmitting detection time information and non-detection time information to the server device, the detection time information indicating a time at which the sound with the predetermined frequency has been detected, and the non-detection time information indicating a time at which a sound detecting unit has stopped detecting the sound with the predetermined frequency; and
a fourth step of grouping, by the server device, two or more portable communication terminals together based on detection time information and non-detection time information received from a plurality of portable communication terminals, to enable data communication between the grouped portable communication terminals through the network.

11. The communication system according to claim 2, comprising:
a display unit that displays a fact that the sound source is generating the sound with the predetermined frequency, or a vibrator that notifies by vibration that the sound source is generating the sound with the predetermined frequency.

12. The communication system according to claim 7, comprising:
a display unit that displays a fact that the sound source is generating the sound with the predetermined frequency, or a vibrator that notifies by vibration that the sound source is generating the sound with the predetermined frequency.

13. The communication system according to claim 8, comprising:
a display unit that displays a fact that the sound source is generating the sound with the predetermined frequency, or a vibrator that notifies by vibration that the sound source is generating the sound with the predetermined frequency.
